(19) United States
(12) Patent Application Publication
(10) Pub. No.: US 2007/0043898 A1
(43) Pub. Date: Feb. 22, 2007

(54) Information processing system

(75) Inventors: Shinobu Ozeki, Kanagawa (JP); Takeshi Kamimura, Kanagawa (JP); Seiji Suzuki, Kanagawa (JP); Masaru Kijima, Kanagawa (JP); Jun Kitamura, Kanagawa (JP); Yoshihide Sato, Kanagawa (JP); Junji Okada, Kanagawa (JP); Shinya Kyozuka, Kanagawa (JP); Takehiro Niitsu, Kanagawa (JP); Kazuhiro Sakai, Kanagawa (JP); Kazuhiro Suzuki, Kanagawa (JP); Tsutomu Hamada, Kanagawa (JP); Norihiko Kuroishi, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/483,502

(22) Filed: Jul. 10, 2006

(30) Foreign Application Priority Data
Aug. 19, 2005 (JP) P2005-238710

(51) Int. Cl. G06F 12/00

(52) U.S. Cl. 711/100

(57) ABSTRACT

An information processing system includes a host device, a storage device and a bus. The bus transmits data to which an error correction code is appended, between the host device and the storage device. The storage device includes a storage section that stores the data. The storage device writes and reads the data received from the bus to and from the storage section with the error correction code appended to the data.

This application claims priority under ±USC 119 from Japanese patent application No. 2005-238710 filed on Aug. 19, 2005, the disclosure of which is incorporated by reference herein.

### BACKGROUND

1. Technical Field

The present invention relates to an information processing system performing data transmission between a host device and a storage device at high speed via an optical bus.

2. Related Art

In conjunction with enhancement of semiconductor technology, operation frequencies of CPUs or main memories have been increased. In order for taking full advantage of these CPUs or main memories, it is required for transmission channels connecting between the CPUs and the main memories to have transmission bands suitable for the operation frequencies of the CPUs or the main memories. For example, in the case of an information processing system including a host device having a CPU as a core and a storage device including a semiconductor memory connected to each other, selection of the formation of the transmission channel linking the host device with the storage device has a decisive influence on the performance of the overall system. In general, the possible way to increase the transmission band is to increase the bit width of the transmission channel or to increase the transmission frequency. However, in recent years, the parallel bus such as SCSI, which increases the transmission band by increasing the bit width, has been giving place of the main stream to the serial bus, which increases the transmission frequency with a smaller number of bits.

In data transmission with a high transmission frequency such as in the serial bus, it is important to enhance reliability by preventing transmission errors. For example, in order for removing the direct current component susceptible to noises to remove a cause of degradation of the transmission quality such as inter symbol interference, DC balance adjustment is preformed for making the transmission data to include 0 and 1 in an appropriate proportion. In a method known as 8B10B, data is separated into blocks every eight bits, and each of the blocks is converted into ten bit data to include 0 and 1 in a predetermined proportion of about 50%, thereby adjusting the DC balance. However, if the system requires higher transmission quality, an error correction function is indispensable. For example, a method, such as a Hamming code, is known, in which a redundancy bit for error detection is appended to original data, presence of any errors is detected after transmission, and correction of any errors is performed.

Further, according to a related art, in order for enhancing reliability of data writing into semiconductor memories, semiconductor memories with an error correction function have been introduced. This function is only performed between a memory controller and a semiconductor memory to write the original data with the redundancy bit appended thereto and check the data in a reading out operation using the redundancy bit.

Further, since an amount of memory space handled by a single system has become larger, it has been required that CPUs are able to access to a larger amount of memory chips.

However, a memory bus in a storage device according to a related art, which includes metal wiring, is not capable of meeting the needs of high-speed and high-capacity transmission. Therefore, a method of performing connections between boards or chips with optical interconnections instead of the metal wiring is now attracting attention.

FIG. 5 shows an example of an information processing system according to a related art. The information processing system 100 includes a host device 10 and a plurality of memory devices 30A, 30B connected to the host device 10 via an interface 20 including an optical bus 21.

The host device 10 includes a CPU 11 for totally controlling the host device 10, a bus controller 12 connected to the CPU 11 and for controlling data communication, an electro-optic conversion section 13 connected to the bus controller 12 and the optical bus 21 and for converting an electrical signal into an optical signal, and a photoelectric conversion section 14 connected to the bus controller 12 and the optical bus 21 and for converting an optical signal to an electrical signal.

The bus controller 12 includes a DC balance conversion section 121 connected to the CPU 11 and for performing the DC balance conversion, a parallel-to-serial conversion section 122 connected to the DC balance conversion section 121 and for converting low speed parallel data into high speed serial data, an error-detection-bit appending section 123 for appending an error detection bit to the serial data output from the parallel-to-serial conversion section 122, an error detection/correction section 124 for detecting an error in data output from the photoelectric conversion section 14 and performing error correction according to needs, an error-detection-bit removing section 125 for removing the error detection bit from data output from the error detection/correction section 124, a serial-to-parallel conversion section 126 for converting high speed serial data output from the error-detection-bit removing section 125 into low speed parallel data, and a DC balance inverse conversion section 127 for performing DC balance inverse conversion on data output from the serial-to-parallel conversion section 126.

The interface 20 includes the optical bus 21 for bi-directionally transmitting optical data with an optical guide or an optical fiber and connectors (not shown) for performing the optical transmission between the optical bus 21 and each of the host device 10 and the memory devices 30A, 30B. It is noted that the interface 20 can be configured to be independent from the host device 10 or to be integrated with the host device 10.

Since the memory devices 30A, 30B have the same configurations, only the configuration of the memory device 30A will be explained here. The memory device 30A includes a photoelectric conversion section 31A connected to the optical bus 21 and for converting an optical signal output from the optical bus 21 into an electric signal, an electro-optic conversion section 32A for converting an electric signal (data) from the memory into an optical signal, a bus controller 33A for controlling connection between the optical bus 21 and each of the photoelectric conversion section 31A and the electro-optic conversion section 32A, a memory 34A with an error correction function provided with an error correction function, and a memory controller 35A connected to the bus controller 33A and the memory 34A with an error correction function and for writing data to or retrieving data from the memory 34A with an error correction function. The bus controller 33A, in detail, has the same function as the bus controller 12 included in the host device 10. The bus controller 12 in the host device 10 provides an interface function between the CPU 11 of the host device 10 and the bus, while the bus controller 33A in the memory device 30A provides an interface function between the memory controller 35A and optical bus 21.

(Flow of Signal Processing in Information Processing System)

The operation of the information processing system 100 will now be explained with reference to FIGS. 5 and 6.

FIG. 6 shows a flow of the signal processing in the information processing system 100 shown in FIG. 5. Namely, FIG. 6 shows the flow of the signal processing in the case in which the original data 15 in the host device 10 or acquired from the outside is written to the memory device 30A, and the host device 10 then retrieves the data from the memory device 30A. Note that, although the data transmission between the host device 10 and the memory device 30A is described here, the same is applied to the data transmission between the host device 10 and the memory device 30B.

In the host device 10, firstly, the CPU 11 controls the DC balance conversion section 121 shown in FIG. 5 to perform a DC balance conversion process for appropriately switching between “0” and “1” on the original data 15 so that the noise resistance is improved to reduce the inter symbol interference, to generate parallel data 16.

Subsequently, the CPU 11 makes the parallel-to-serial conversion section 122 operate to convert the parallel data 16 into serial data 17. Then, the CPU 11 makes the error-detection-bit appending section 123 operate to generate data 19 by adding the error correction bit 18 (the redundancy bit) to the serial data 17, and transmits the data 19 to the electro-optic conversion section 13. The electro-optic conversion section 13 converts the data 19 from the error-detection-bit appending section 123 into an optical signal, and transmits it to the memory device 30A via the interface 20.

In the memory device 30A, the data 19 from the interface 20 is converted into an electrical signal by the photoelectric conversion section 31A. The bus controller 33A performs the error detection and the error correction based on the error detection on the data 19 from the photoelectric conversion section 31A, then converts the serial data 17 into the parallel data 16, further performs the DC balance inverse conversion on the parallel data 16 to generate the original data 15, and transmits it to the memory controller 35A.

The memory controller 35A generates data 41 by adding an error correction bit 40 to the original data 15. The data 41 is stored in the memory 34A with an error correction function.

Subsequently, when the CPU 11 of the host device 10 outputs an instruction for retrieving the data to the memory device 30A, the memory controller 35A retrieves data 41 stored in the memory 34A with an error correction function. The memory controller 35A generates the original data 15 by removing the error correction bit 40 from the data 41. The original data 15 is then transmitted to the bus controller 33A.

The bus controller 33A generates the parallel data 16 by performing the DC balance conversion on the original data 15. Further, the bus controller 33A converts the parallel data 16 into the serial data 17, and then generates the data 19 by adding the error correction bit 42 to the serial data 17. The data 19 including the error correction bit 42 added thereto is converted into an optical signal by the electro-optic conversion section 32A and then transmitted to the host device 10 via the interface 20.

It is assumed that an error by an erroneous bit 43 is caused in the data 17 in the process of transmitting the data 19 from the memory device 30A to the host device 10. The data 19 is received by the photoelectric conversion section 14 as an optical signal, and transmitted to the bus controller 12 after converted into an electrical signal.

In the bus controller 12, firstly, the error detection/correction section 124 operates. The error detection/correction section 124 performs the error correction to generate the 19 in response to detection of the error bit 43. Subsequently, the CPU 11 makes the error-detection-bit removing section 125 operate to remove the error correction bit 42 from the data 19, and converts it into the parallel data 16 by the serial-to-parallel conversion section 126. Further, the CPU 11 makes the DC balance inverse conversion section 127 operate to perform the DC balance inverse conversion on the data 16, thereby reproducing the original data 15.

### SUMMARY

According to one aspect of the invention, an information processing system includes a host device, a storage device and a bus. The bus transmits data to which an error correction code is appended, between the host device and the storage device. The storage device includes a storage section that stores the data. The storage device writes and reads the data received from the bus to and from the storage section with the error correction code appended to the data.

### BRIEF DESCRIPTION OF THE DRAWINGS

FIG. 1 is a block diagram showing an information processing system according to a first exemplary embodiment of the invention;

FIG. 2 is an explanatory chart for showing signal processing executed by the information processing system shown in FIG. 1;

FIG. 3 is a block diagram showing an information processing system according to a second exemplary embodiment of the invention;

FIG. 4 is an explanatory chart for showing signal processing executed by the information processing system shown in FIG. 3.

FIG. 5 is a block diagram showing a conventional information processing system; and

FIG. 6 is an explanatory chart for showing signal processing executed b by the information processing system shown in FIG. 5.

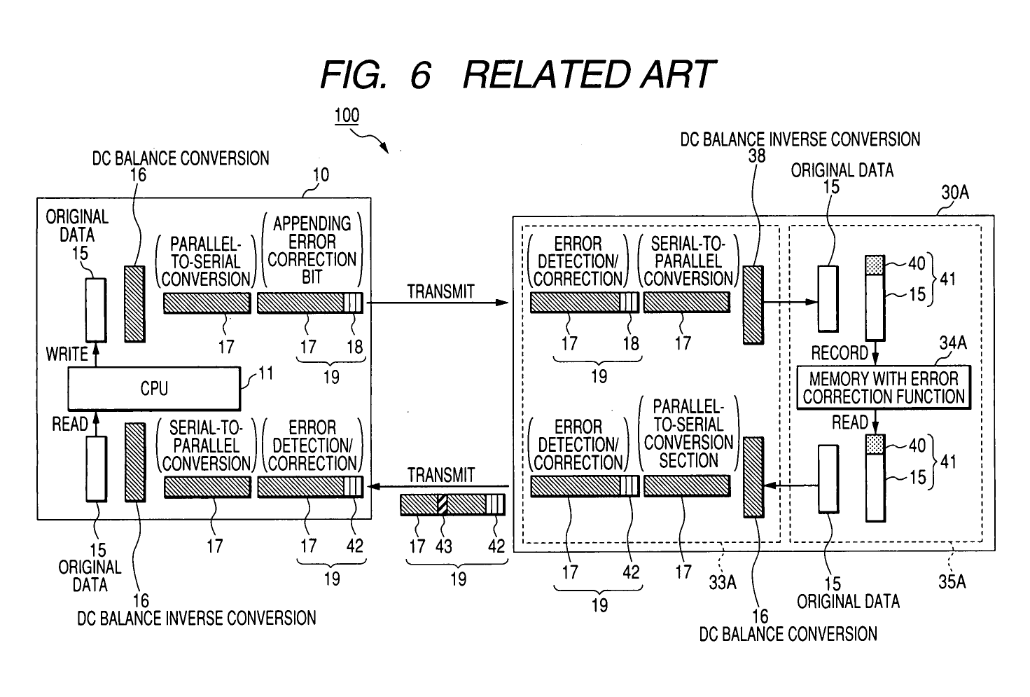

### DETAILED DESCRIPTION

### First Exemplary Embodiment

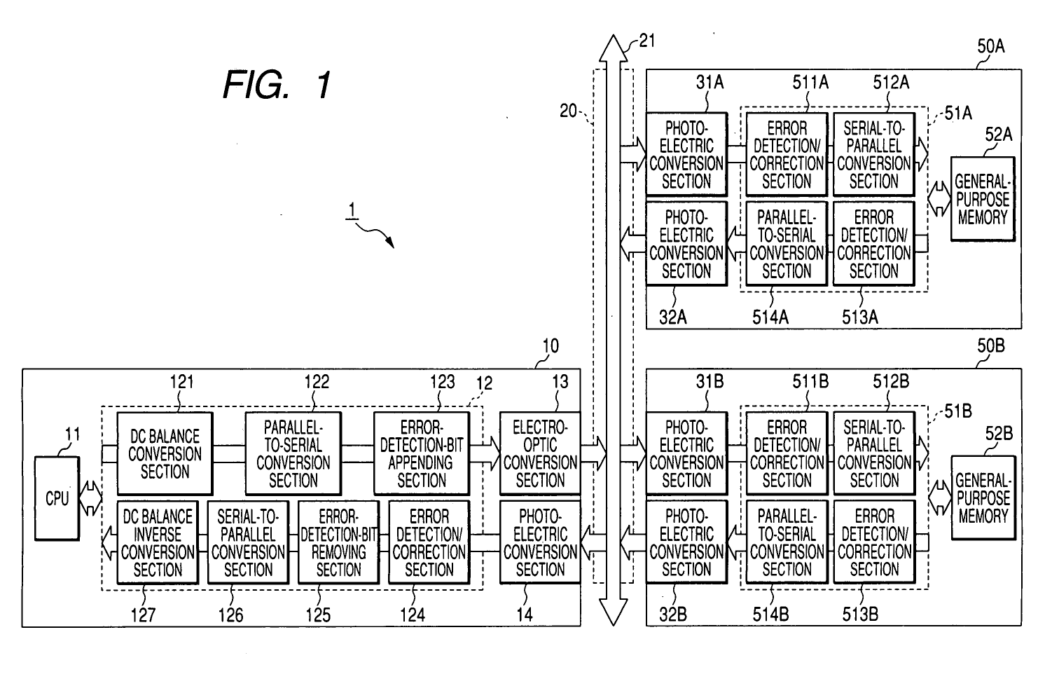

FIG. 1 shows an information processing system according to a first exemplary embodiment of the invention. The information processing system 1 includes the host device 10 and memory devices 50A, 50B as a plurality of storage devices connected to the host device 10 via the interface 20 including the optical bus 21. Note that the number of memory devices connected to the interface 20 is not limited to two, but can be one, or three or more.

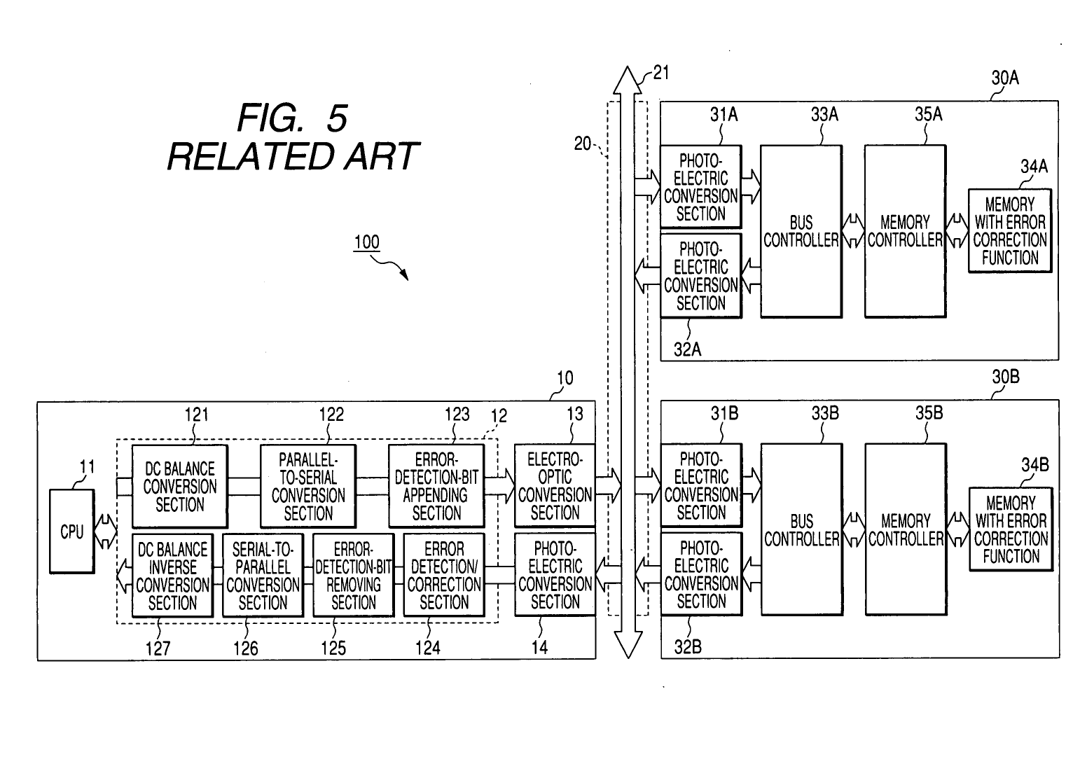

The host device 10 has the same configuration as shown in FIG. 5, and includes the CPU 11, the bus controller 12, the electro-optic conversion section 13, and the photoelectric conversion section 14.

The bus controller 12 has the same configuration as shown in FIG. 5, and includes the DC balance conversion section 121, the parallel-to-serial conversion section 122, the error-detection-bit appending section 123, the error detection/correction section 124, the error-detection-bit removing section 125, the serial-to-parallel conversion section 126, and the DC balance inverse conversion section 127.

The electro-optic conversion section 13 includes, for example, a light emitting element such as a semiconductor laser or LED and a driver for driving the light emitting element, and converts an electrical binary signal including “1” and “0” states into an optical binary signal.

The photoelectric conversion section 14 is for converting intensity level of light into an electrical binary signal, and including, for example, a photodiode for converting light into electric current and an amplifier for converting the minute electric current from the photodiode into an electrical signal and amplifying it.

The interface 20 includes the optical bus 21 for bi-directionally transmitting optical data with an optical guide or an optical fiber and connectors (not shown) for performing the optical transmission between the optical bus 21 and each of the host device 10 and the memory devices 50A, 50B. Speeding up of the interface 20 can be achieved by using a technology such as an optical coupler or an optical sheet bus. Note that the interface 20 can be configured to be independent from the host device 10 or to be integrated with the host device 10.

Since the memory devices 50A, 50B have the same configurations, the memory device 50A will only be explained here. Besides the photoelectric conversion section 31A and the electro-optic section 32A shown in FIG. 5, the memory device 50A includes a bus/memory controller connected to the photoelectric conversion section 31A and the electro-optic section 32A and for performing data transmission with the outside and writing and reading of data, and a general-purpose memory 52A, without the error correction function, connected to the bus/memory controller 51A to store the data.

The bus/memory controller 51A includes the photoelectric conversion section 31A, the electro-optic conversion section 32A, an error detection/correction section 511A as a first error checking section for performing correction in accordance with error detection on the data from the photoelectric conversion section 31A, a serial-to-parallel conversion section 512A for converting the serial data from the error detection/correction section 511A into parallel data, an error detection/correction section 513A as a second error checking section for performing correction in accordance with error detection on the data read out from the general-purpose memory 52A, and a parallel-to-serial conversion section 514A for converting the parallel data from the error detection/correction section 513A into serial data.

Operation of the Information Processing System

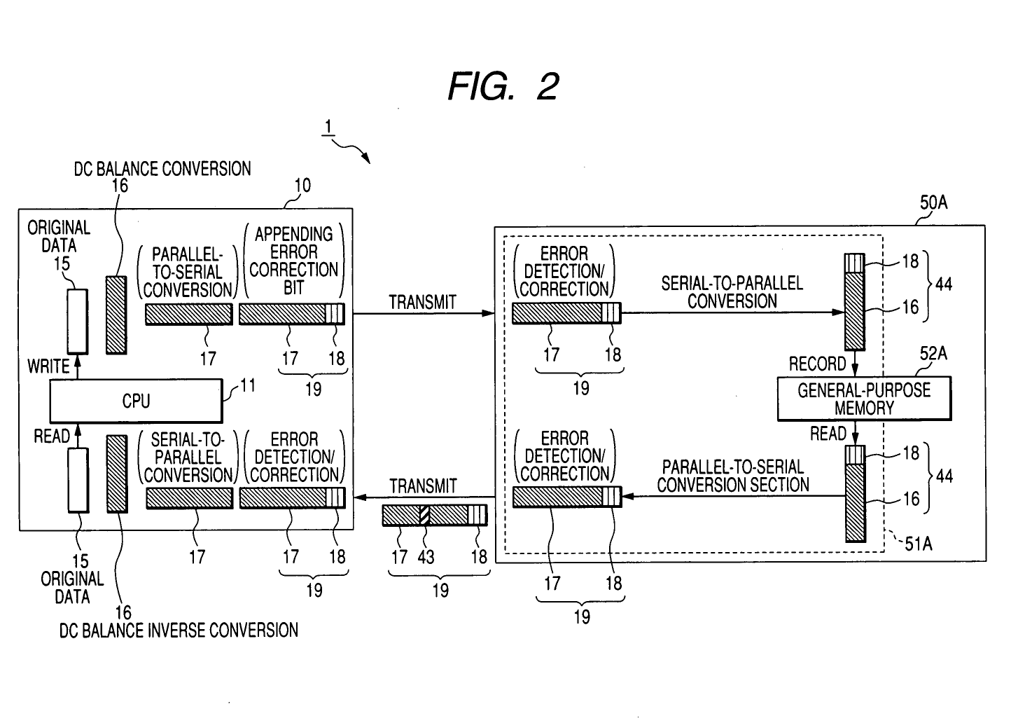

The operation of the information processing system 1 will now be explained with reference to FIGS. 1 and 2. FIG. 2 shows a flow of the signal processing in the information processing system 1 shown in FIG. 1.

1. Data Writing Operation

The case in which data is transmitted from the host device 10 to the memory device 50A is explained first. In this case, the CPU 11 controls the DC balance conversion section 121 to perform the DC balance conversion process on the original data 15 in accordance with 8B10B, thereby generating the parallel data 16. Specifically, it is converted into the data with a mixing ratio of “0” and “1” near to 50%.

Subsequently, the CPU 11 makes the parallel-to-serial conversion section 122 operate to convert the parallel data 16 from the DC balance conversion section 121 into the serial data 17 in order for adjusting difference between the optical signal, which can be driven with high speed, and the electrical signal.

Then, the CPU 11 makes the error-detection-bit appending section 123 operate to generate the data 19 by appending the error correction bit 18, which is an ECC code, to the serial data 16. The Hamming code used generally can be used for generating the data 19. Further, the data 19 is added with inverted data of the error correction bit 18. Thus, the condition in which the DC balance is kept can be obtained. Subsequently, the electro-optic conversion is performed on the data 19 by the electro-optic conversion section 13, and the optical signal is transmitted to the memory device 50A via the interface 20.

In the memory device 50A, the data 19 from the interface 20 is converted into an electrical signal by the photoelectric conversion section 31A. The bus/memory controller 51A checks the data from the photoelectric conversion section 31A, and generates the data 19 by performing any error correction in accordance with any errors. The data 19 is converted into the parallel data 44 by the serial-to-parallel conversion section 512A, and then stored in the general-purpose memory 52A.

2. Data Read-Out Operation

A procedure of reading out data from the general-purpose memory 52A of the memory device 50A and transmitting the data to the host device 10 will now be explained. Firstly, the bus/memory controller 51A receiving a reading instruction from the host reads out the data 44, which has been processed with the DC balance conversion and including the error correction bit 18 appended thereto, from the general-purpose memory 52A, and input it to the error detection/correction section 513A of the bus/memory controller 51A.

The error detection/correction section 513A checks the data 44, and performs any error correction in accordance with any errors. The data 44 is converted into the serial data 19 by the parallel-to-serial conversion section 514A. The data 19, which has been processed with the DC balance conversion and including the error correction bit 18 appended thereto, is transmitted from the memory device 50A to the host device 10 via the interface 20.

In the host 10, the data 19 from the interface 20 is received in the photoelectric conversion section 14, and the optical signal is converted into the electrical signal data 19. The data 19 thus converted is sent to the error detection/correction section 124 of the bus controller 12.

If any errors occur in the process of transmitting the data 19 from the memory device 50A to the host device 10, correction of the erroneous bit 43 is performed by the error detection/correction section 124, and the data 19 is generated. Subsequently, the error-detection-bit removing section 125 removes the error correction bit 18 from the data 19. Further, the serial-to-parallel conversion section 126 converts it into the parallel data 16. And finally, the DC balance inverse conversion section 127 performs the DC balance inverse conversion thereon to restore the original data 15.

Note that, although the data transmission between the host device 10 and the memory device 50A is described in FIG. 2, the same is applied to the case with the host device 10 and the memory device 50B.

### Second Exemplary Embodiment

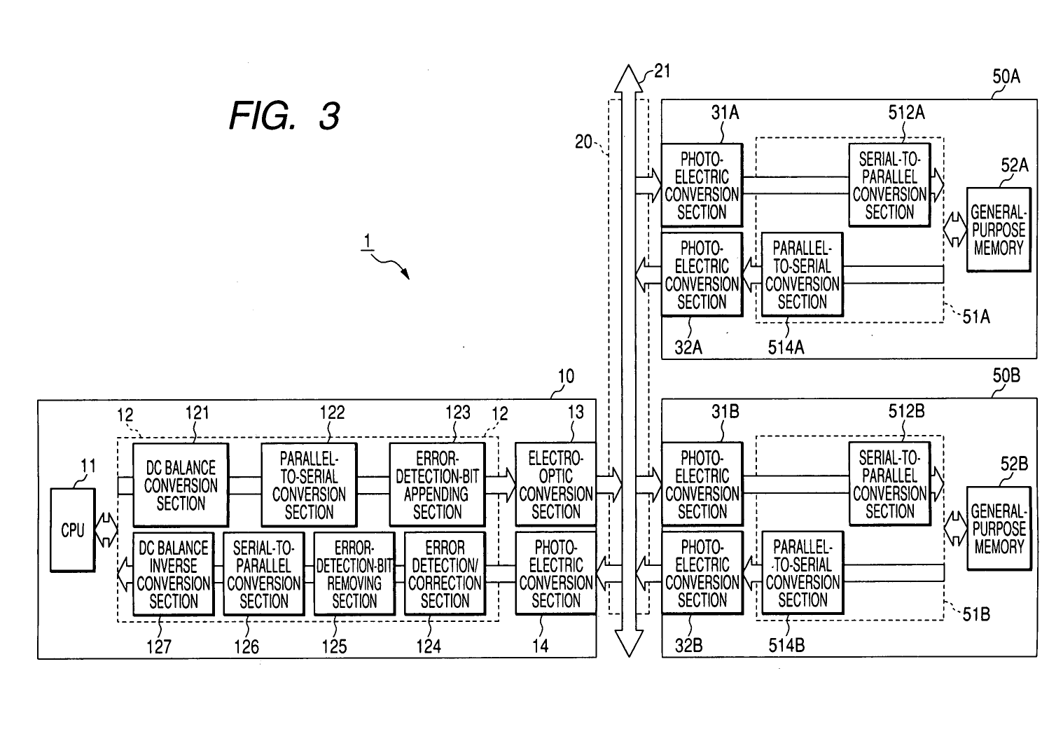

FIG. 3 shows an information processing system according to a second exemplary embodiment of the invention. In the present embodiment, the error detection/correction sections 511A, 511B, and the error detection/correction sections 513A, 513B are removed from the bus/memory controllers 51A, 51B in the first exemplary embodiment, and other elements of the configuration are the same as the first exemplary embodiment.

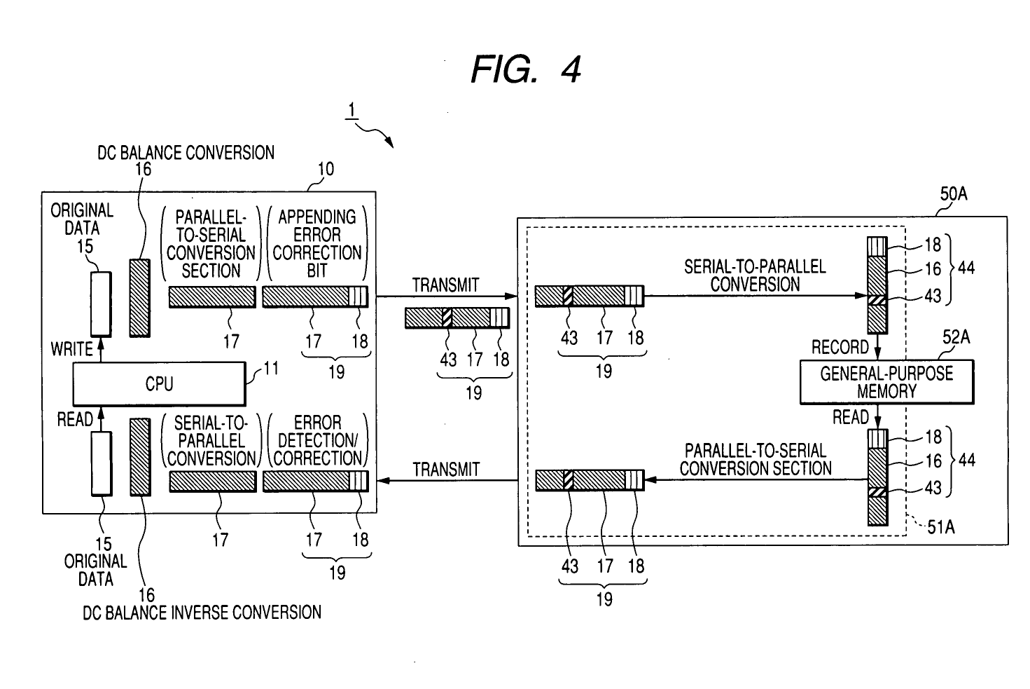

The operation of the information processing system 1 will now be explained with reference to FIGS. 3 and 4. FIG. 4 shows a flow of the signal processing in the information processing system 1 shown in FIG. 3. In FIG. 4, the data sending operation in the host device 10 is the same as in the first exemplary embodiment shown in FIG. 2, and accordingly, the explanations will be omitted here.

In the memory device 50A, the photoelectric conversion section 31A converts the data 19 from the interface 20 into an electrical signal data. And, the data 19 is further converted into the parallel data 44 by the serial-to-parallel conversion section 512A of the bus/memory controller 51A. Here, even if an error caused by the erroneous bit 43 occurs in the transmission process from the host device 10 to the memory device 50A, the data 44 is written as it is to the general-purpose memory 52A.

The case in which the data 44 is read out from the general-purpose memory 52A and transmitted to the host device 10 will now be explained. Firstly, the data 44, which has been processed with the DC balance conversion and including the error correction bit 18 appended thereto, is read out from the general-purpose memory 52A by the bus/memory controller 51A. The data 44 includes a down transmission error caused by the erroneous bit 43.

The bus/memory controller 51A converts the parallel data 44 into the serial data 19 by the parallel-to-serial conversion section 514A. The serial data 19 is kept including the error bit 43. The data 19 including the erroneous bit 43 is converted into an optical signal by the electro-optic conversion section 32A and then transmitted to the host device 10 via the interface 20.

In the host device 10, the photoelectric conversion section 14 converts it into the electrical signal data 19, and then the error detection/correction section 124 checks the data 19 to generate the data 19 corrected in the erroneous bit 43. Further, the error-detection-bit removing section 125 removes the error correction bit 18 from the data 19. Subsequently, the serial-to-parallel conversion section 126 converts the serial data 17 into the parallel data 16, and the DC balance inverse conversion is performed on the parallel data 16 to be put back to the original data 15.

Note that, although the data transmission between the host device 10 and the memory device 50A is described in FIG. 4, the same is applied to the data transmission between the host device 10 and the memory device 50B.

### Other Exemplary Embodiments

Note that the invention is not limited to each of the embodiments described above, but can be put into practice in variously modified forms within the scope or the spirit of the invention. For example, although in the embodiments described above the transmission between the host device and the memory device is explained, it can be applied to the devices performing bi-directional data communication such as a host device and a network device. Further, it can also be applied to other devices performing unidirectional communication such as an image sending device and an image receiving device. Further, although in the above embodiments, the case in which a plurality of memory devices are connected to the host device is explained, only one memory device will also do.

What is claimed is:

1. An information processing system comprising:
a host device;
a storage device; and
a bus that transmits data to which an error correction code is appended, between the host device and the storage device, wherein:
the storage device comprises a storage section that stores the data, and
the storage device writes and reads the data received from the bus to and from the storage section with the error correction code appended to the data.

2. The system according to claim 1, wherein the host device comprises
a DC balance conversion section that performs DC balance conversion on data;
an error-detection-bit appending section that appends the error correction code to the data, which is subjected to the DC balance conversion, and transmits the data to which the error correction code is appended to the storage device via the bus;
an error detection/correction section that performs error detection and error correction on data output from the storage device; and
a DC balance inverse conversion section that performs DC balance inverse conversion on the data output from the error detection/correction section.

3. The system according to claim 1, wherein the storage device comprises:
a memory controller that writes and reads the data to which the error correction code is appended, to and from the storage section;
a bus controller that mutually converts between a signal of the memory controller and a signal of the bus;
a first error detection/correction section that performs error detection and error correction on the data received from the bus; and
a second error detection/correction section that performs error detection and error correction on the data retrieved from the storage section.

4. The system according to claim 2, wherein the storage device comprises:
a memory controller that writes and reads the data to which the error correction code is appended, to and from the storage section;
a bus controller that mutually converts between a signal of the memory controller and a signal of the bus;
a first error detection/correction section that performs error detection and error correction on the data received from the bus; and
a second error detection/correction section that performs error detection and error correction on the data retrieved from the storage section.

5. The system according to claim 1, wherein the host device and the storage device serialize parallel data and transmit the serialized data via the bus.

6. The system according to claim 2, wherein the host device and the storage device serialize parallel data and transmit the serialized data via the bus.

7. The system according to claim 3, wherein the host device and the storage device serialize parallel data and transmit the serialized data via the bus.

8. The system according to claim 4, wherein the host device and the storage device serialize parallel data and transmit the serialized data via the bus.

9. The information processing system according to claim 1, wherein the bus performs data transmission with using an optical signal.

10. The information processing system according to claim 2, wherein the bus performs data transmission with using an optical signal.

11. The information processing system according to claim 3, wherein the bus performs data transmission with using an optical signal.

12. The information processing system according to claim 4, wherein the bus performs data transmission with using an optical signal.

13. The information processing system according to claim 5, wherein the bus performs data transmission with using an optical signal.

14. The information processing system according to claim 6, wherein the bus performs data transmission with using an optical signal.

15. The information processing system according to claim 7, wherein the bus performs data transmission with using an optical signal.

16. The information processing system according to claim 8, wherein the bus performs data transmission with using an optical signal.
